(19) United States
(12) Patent Application Publication
(10) Pub. No.: US 2009/0093557 A1
(43) Pub. Date: Apr. 9, 2009

(54) METHOD FOR OPTIMIZATION OF RPET DECONTAMINATION

(76) Inventors: L. Robert Deardurff, Waterville, OH (US); Donald W. Hayward, Waterville, OH (US)

Correspondence Address: FRASER CLEMENS MARTIN & MILLER LLC, 28366 KENSINGTON LANE, PERRYSBURG, OH, 43551, US

(21) Appl. No.: 12/247,399

(22) Filed: Oct. 8, 2008

Related U.S. Application Data
(60) Provisional application No. 60/978,243, filed on Oct. 8, 2007.

(51) Int. Cl. C08J 11/08

(52) U.S. Cl. 521/48

(57) ABSTRACT

A process for decontaminating recycled polyethylene terephthalate (RPET) is disclosed, the process involves determining an accumulated thermal history (ATH) of the RPET, including the thermal history of any process steps performed by a subsequent possessor of the RPET, to result in an optimized decontamination process for decontaminating the RPET to a desired level.

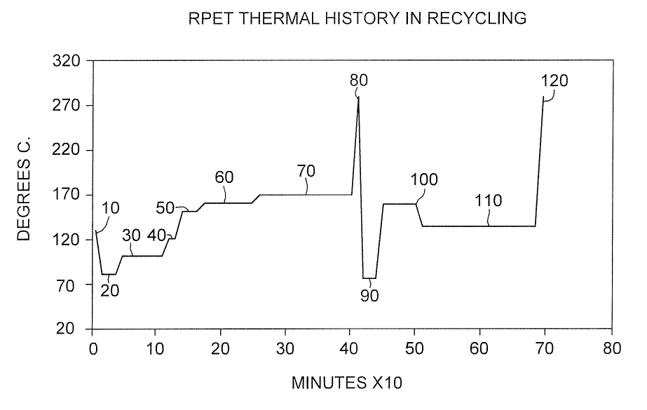

### CROSS-REFERENCE TO RELATED APPLICATION

This application claims the benefit of U.S. Provisional Patent Application Ser. No. 60/978,243 filed on Oct. 8, 2007, hereby incorporated herein by reference in its entirety.

### FIELD OF THE INVENTION

The invention relates generally to a process for treating recycled polyethylene terephthalate (RPET) for decontamination. More particularly, the invention is directed to an optimized process for treating contaminated RPET to cause an outward diffusion of trapped contaminants.

### BACKGROUND OF THE INVENTION

Polyethylene terephthalate (PET) resin is widely used for containers, such as carbonated soft drink (CSD) bottles and other packages. Post-consumer recycled polyethylene terephthalate is widely processed into useful products. The recycling process begins when used PET containers, such as carbonated beverage bottles, are collected, sorted, washed, and separated to yield a clean, mostly pure source of RPET.

A critical aspect of processing RPET, and a key to achieving a consistently high-quality end product, is the comprehensive decontamination of the RPET flakes. The RPET flakes may be decontaminated using a variety of processes including a washing process and a drying process. Because the rates of diffusion of contaminants from the RPET will increase as the temperature of the RPET increases, each process that utilizes a temperature above about 60° C. cumulatively contributes to the overall decontamination of the RPET. Each process that utilizes a temperature above 60° C. will incrementally decontaminate the RPET, and the RPET will have a thermal history associated with each process step. The thermal histories of each process step are combined to determine an accumulated thermal history (ATH) of the RPET.

Although a substantial amount of decontamination occurs during the washing and sorting processes, it is known that “clean” RPET flakes can still contain residual contaminants in concentrations as high as about 4%. These contaminants are predominately label and basecup glues, polyolefins, PVC, paper, glass, moisture, and metals. All of these contaminants negatively affect the quality and performance of the finished product. Of recent concern are the infrequent toxic contaminants which may be introduced into the recycle stream. Examples of these contaminants are pesticides, solvents, herbicides, and chlorinated hydrocarbons, which could contaminate RPET through incidental contact, or by the recycling of a PET container which was used by the consumer to hold a toxic substance for some period of time. These sources of contamination, although rare, are nevertheless appropriately of great concern to those who would incorporate RPET into containers for food-contact use. With regard to this possibility, the FDA has set protocols for the levels of such contamination in food-contact applications, and has established surrogates and concentration limits to establish the effectiveness of the decontamination methods. Accordingly, the RPET must be decontaminated to an acceptable level before it may be sold and converted into plastic containers or other plastic products.

A significant drawback to known decontamination processes is that the processes are time-consuming, and therefore, the costs to manufacture resin employing the processes are high. Additionally, the effect of further processing, conversion, and decontamination of the RPET by a subsequent possessor of the RPET, such as a purchaser, a converter, or a manufacturer, is not accounted for during the original process of decontamination of the RPET. After the subsequent possessor obtains the decontaminated RPET, the RPET must be further dried, thereby subjecting the RPET to elevated temperatures and therefore, further decontamination of the RPET. The additional drying step by the subsequent possessor decontaminates the RPET to a level beyond the acceptable level of decontamination, thereby increasing process time and process costs.

It would be desirable to optimize the decontamination of RPET by determining the ATH of the RPET, including any process steps performed by a subsequent possessor.

### SUMMARY OF THE INVENTION

Concordant and congruous with the present invention, an optimized process for the decontamination of RPET involving the determination of the ATH of the RPET, including any process steps performed by a subsequent possessor, has surprisingly been discovered.

The inventive process is particularly useful for treating RPET for subsequent use in the preparation of food-grade and other containers.

According to an embodiment of the invention, the process for optimizing a decontamination process for RPET comprises determining the desired decontamination process steps necessary to achieve a desired level of decontamination of RPET including at least one decontamination process step resulting in a first thermal history of the RPET and performed by a possessor of the RPET, and at least one decontamination process step resulting in a second thermal history of the RPET and performed by a subsequent possessor of the RPET; and optimizing the decontamination process step performed by the possessor of the RPET based on the second thermal history to achieve the desired level of decontamination of the RPET when combined with the decontamination process step performed by the subsequent possessor.

According to another embodiment of the invention, the process for decontaminating RPET comprises determining the desired decontamination process steps necessary to achieve a desired level of decontamination of RPET including at least one decontamination process step resulting in a first thermal history of the RPET and performed by a possessor of the RPET, and at least one decontamination process step resulting in a second thermal history of the RPET and performed by a subsequent possessor of the RPET; optimizing the decontamination process step performed by the possessor of the RPE based on the second thermal history to achieve the desired level of decontamination of the RPET when combined with the decontamination process step performed by the subsequent possessor; providing a quantity of RPET flakes containing contaminants; decontaminating the RPET to a level less than the desired level of decontamination with the decontamination process step performed by the possessor; and decontaminating the RPET to the desired level of decontamination with the decontamination process step performed by the subsequent possessor.

According to another embodiment of the invention, the process for decontaminating RPET comprises determining the desired decontamination process steps necessary to achieve a desired level of decontamination of RPET including at least one decontamination process step resulting in a first thermal history of the RPET and performed by a possessor of the RPET, and at least one decontamination process step resulting in a second thermal history of the RPET and performed by a subsequent possessor of the RPET; determining an accumulated thermal history of the RPET with a computer model, wherein the computer model determines the accumulated thermal history by modeling at least one of a particle geometry of the RPET, a temperature of each process step, and a residence time of the RPET at each temperature of each process step; optimizing the decontamination process step performed by the possessor of the RPET based on the second thermal history to achieve the desired level of decontamination of the RPET when combined with the decontamination process step performed by the subsequent possessor; providing a quantity of RPET flakes containing contaminants; decontaminating the RPET to a level less than the desired level of decontamination with the decontamination process step performed by the possessor; and decontaminating the RPET to the desired level of decontamination with the decontamination process step performed by the subsequent possessor.

### BRIEF DESCRIPTION OF THE DRAWING

The above, as well as other advantages of the present invention, will become readily apparent to those skilled in the art from the following detailed description of a preferred embodiment when considered in the light of the accompanying drawing in which a graph of an exemplary process showing the temperature of RPET versus a residence time of the RPET at each step of the process according to an embodiment of the invention is shown.

### DETAILED DESCRIPTION OF THE EMBODIMENT

The following detailed description and appended drawings describe and illustrate various exemplary embodiments of the invention. The description and drawing serve to enable one skilled in the art to make and use the invention, and are not intended to limit the scope of the invention in any manner. In respect of the methods disclosed, the steps presented are exemplary in nature, and thus, the order of the steps is not necessary or critical.

The present invention is directed to a process for treating RPET, wherein the process comprises a step of determining an accumulated thermal history (ATH) of the RPET, including the thermal history of all process steps performed by a subsequent possessor of the RPET. The processes steps studied in determining the ATH of the RPET may include a grinding step, a washing step, a chemical stripping step, a steam stripping step, a crystallization step, a pelletizing step, a melting step, a solid-stating step, and an extrusion step, for example, as desired.

According to the process of the present invention, a desired level of decontamination of the RPET is determined based on the end use of the product formed therefrom. For example, RPET used for food-grade containers requires a level of decontamination greater than a level of decontamination for RPET used for non-food-grade containers. Based on the desired level of decontamination, the thermal history at each process step of the overall decontamination process is determined. Because each step used in the overall process that utilizes a temperature above about 60° C. will incrementally contribute to the overall decontamination of the RPET, the ATH of the RPET may be determined by the summation of the thermal histories of each step of the overall decontamination process.

The ATH may be determined by utilizing a computer model that determines the thermal history of each process step used in the overall process for decontamination. Numerous variables may be used by the model to determine the thermal history of each process step of the overall decontamination process, including a particle geometry of the RPET, a temperature of the particular process step, a residence time of the RPET at the temperature, and other variables related to the atmosphere the RPET is in during each process step, for example. The thermal histories of the RPET at each process step performed by a possessor of the RPET, such as a recycler of RPET or an RPET producer, and a subsequent possessor, as a purchaser, a converter, or a manufacturer, are then combined to determine the ATH of the overall decontamination process. Typically, the thermal histories of any decontamination steps performed by the subsequent possessor are determined first. Then, based on the thermal history of the subsequent possessor decontamination steps, the thermal histories of the process steps performed prior to the subsequent possessor steps are determined. The model then combines the thermal histories of each process step to determine the ATH of the RPET. If the resultant ATH does not decontaminate the RPET to a desired level, the variables and factors of the process steps performed prior to the subsequent possessor steps may be adjusted and new thermal histories for these steps are determined. The model may use a feedback loop to adjust the variables of the process steps performed prior to the subsequent possessor steps until the overall decontamination process results in RPET having the desired level of decontamination.

By factoring in the decontamination steps of the subsequent possessor, the overall decontamination process is optimized to ensure that the RPET flake will be substantially near or at the desired level of decontamination after the subsequent possessor decontamination steps and not decontaminated beyond the desired level, thereby minimizing the overall decontamination process time and costs.

### EXAMPLE

The drawing is a graph of the temperature of the RPET versus a residence time of the RPET at the temperature for each step of an overall decontamination process of the RPET, including the steps performed by a subsequent possessor. The overall decontamination process as shown in the drawing is exemplary in nature. Because the RPET is subjected to temperatures above 60° C. at each step, the RPET is at least partially decontaminated during each step of the overall decontamination process. Accordingly, the drawing represents an ATH graph of the process.

In a first step 10, containers or other PET articles are collected, sorted, and ground into flakes. By the term “flakes” as it is used herein is meant generally a flake form, but may additionally include chunks, spheres, pellets, and the like. Conventional grinding machinery for RPET reduces the RPET to ⅜ inch or 10 mm flakes. Energy from the grinding process typically heats the containers and PET particles to a temperature above 60° C. for several minutes or hours. RPET grinding equipment ensures that a consistent flake size will be produced by employing a grate or screen through which the ground material must pass in order to leave the grinder. The screen has openings of a specific dimension, e.g., ⅜ inch, and thus acts to produce RPET flakes with a predominant dimension equal to the size of the screen. Screens having ⅜ inch apertures are most commonly employed in the RPET industry, although some processors use screen dimensions as large as ½ inch, or as small as ¼ inch. Most equipment made for processing RPET, including grinders, material handling and conveying equipment, dryers, crystallizers, and blowers, are designed to be used with RPET flakes of about ⅜ inch size. In addition, most extruders and extruder screws are designed to work best with flakes of this dimension. The bulk density of ⅜ inch flake RPET is typically 22 to 35 pounds per cubic foot.

In a second step 20, the RPET flakes are washed in a fluid such as water or a solvent as known in the art. Surfactants and other cleaning aids may be used with the fluid, as desired. The flakes are washed in the fluid at a temperature above 60° C. for several minutes or hours. In a third step 30, a caustic agent or stripping agent may be used to remove a contaminated outer surface of the RPET flakes. The chemical stripping typically occurs at a temperature above 60° C. for several minutes or hours. In a fourth step 40, heated water or steam is used to remove contaminants from the flakes. Steam stripping typically occurs at or above 100° C. for several minutes or hours.

In a fifth step 50, the flakes may be further ground, pulverized, or otherwise comminuted to increase a surface area of the RPET to further optimize decontamination. The flakes may be comminuted by any conventional means to prepare RPET particles having an average mean particle size from about 0.005 inch to about 0.1 inch in diameter. Preferably, the particle size ranges from about 0.005 inch to about 0.05 inch. This is a substantial reduction in the size of the individual RPET flakes, and will allow any contaminant contained within the RPET flakes to be driven out more easily and quickly. The comminution step of the fifth step 50 may occur at or above a temperature of 80° C. for several minutes or hours.

In a sixth step 60, the RPET flakes may be crystallized in hot air to minimize agglomeration and flake surface moisture, and to maximize a bulk density of the flakes. The hot air crystallization may occur at or above a temperature of 120° C. for several hours. In a seventh step 70, the RPET may be dried in a PET dryer as known in the art. RPET is a hygroscopic polymer that must be thoroughly dried prior to melt processing in order to prevent hydrolytic degradation and a resultant loss of intrinsic viscosity. Drying of PET and RPET flakes usually occurs in commercially available desiccant hot air dryers which are designed to remove moisture from the surface and matrix of the material. Drying is typically conducted at temperatures which are above the boiling point of water but well below solid-stating temperatures.

In an eighth step 80, the RPET flakes are melted in an extruder. The RPET flakes are typically subjected to temperatures at or above 230° C. for less than a minute. However, the melt residence time of the RPET may be maximized by using extruders having a special screw design such as a two-stage decompression screw or vacuum-vented barrels. In a ninth step 90, the RPET melt is extruded. The extrusion may be a fiber extrusion, filament extrusion, pellet extrusion or any other extruded or injected shape, as desired. Latent heat in the extruded RPET may result in temperatures at or above 60° C. for several minutes or hours. In a tenth step 100, the RPET pellets or fibers may be crystallized in hot air to mitigate against the sticking together of the pellets and to remove surface moisture. The hot air crystallization of the tenth step 100 may occur at or above a temperature of 120° C. for several minutes or hours.

After the tenth step 100, the pellets are decontaminated to a level below the desired level. The pellets are then transported to the subsequent possessor for further decontamination and processing. The subsequent possessor may perform an eleventh step 110 that includes the drying of the RPET pellets in a dryer. The drying may occur at or above a temperature of 120° C. for several hours. Drying of the pellets usually occurs in commercially available desiccant hot air dryers designed to remove moisture from the surface and matrix of the material. Drying is conducted at temperatures which are above the boiling point of water but well below solid-stating temperatures. In a twelfth step 120, the RPET pellets are melted by a combination of heating elements and shear heating from the extrusion screw of an extruder. The RPET pellets are typically subjected to temperatures at or above 230° C. for less than a minute. However, the melt residence time of the RPET pellets in the pellets may be maximized by using extruders having a special screw design such as a two-stage decompression screw or vacuum-vented barrels. After the twelfth step 120, the RPET is decontaminated to the desired level.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A process for optimizing a decontamination process for RPET, comprising:
determining the desired decontamination process steps necessary to achieve a desired level of decontamination of RPET including at least one decontamination process step resulting in a first thermal history of the RPET and performed by a possessor of the RPET, and at least one decontamination process step resulting in a second thermal history of the RPET and performed by a subsequent possessor of the RPET; and
optimizing the decontamination process step performed by the possessor of the RPET based on the second thermal history to achieve the desired level of decontamination of the RPET when combined with the decontamination process step performed by the subsequent possessor.

2. The process of claim 1, wherein the decontamination step performed by the possessor is one of a drying step, a grinding step, a washing step, a chemical stripping step, a steam stripping step, a crystallization step, a pelletizing step, a melting step, a solid-stating step, and an extrusion step.

3. The process of claim 1, wherein the decontamination step performed by the subsequent possessor is one of a drying step, a grinding step, a washing step, a chemical stripping step, a steam stripping step, a crystallization step, a pelletizing step, a melting step, a solid-stating step, and an extrusion step.

4. The process of claim 1, wherein each of the desired process steps is performed at a temperature above about 60° C.

5. The process of claim 1, further comprising the step of determining an accumulated thermal history of the RPET with a computer model.

6. The process of claim 5, wherein the computer model determines the accumulated thermal history by modeling at least one of a particle geometry of the RPET, a temperature of each process step, and a residence time of the RPET at each temperature of each process step.

7. A process for decontaminating RPET, comprising:
determining the desired decontamination process steps necessary to achieve a desired level of decontamination of RPET including at least one decontamination process step resulting in a first thermal history of the RPET and performed by a possessor of the RPET, and at least one decontamination process step resulting in a second thermal history of the RPET and performed by a subsequent possessor of the RPET;
optimizing the decontamination process step performed by the possessor of the RPET based on the second thermal history to achieve the desired level of decontamination of the RPET when combined with the decontamination process step performed by the subsequent possessor,
providing a quantity of RPET flakes containing contaminants;
decontaminating the RPET to a level less than the desired level of decontamination with the decontamination process step performed by the possessor; and
decontaminating the RPET to the desired level of decontamination with the decontamination process step performed by the subsequent possessor.

8. The process of claim 7, wherein the decontamination step performed by the possessor is one of a drying step, a grinding step, a washing step, a chemical stripping step, a steam stripping step, a crystallization step, a pelletizing step, a melting step, a solid-stating step, and an extrusion step.

9. The process of claim 7, wherein the decontamination step performed by the subsequent possessor is one of a drying step, a grinding step, a washing step, a chemical stripping step, a steam stripping step, a crystallization step, a pelletizing step, a melting step, a solid-stating step, and an extrusion step.

10. The process of claim 7, wherein each of the desired process steps is performed at a temperature above about 60° C.

11. The process of claim 7, further comprising the step of determining an accumulated thermal history of the RPET with a computer model.

12. The process of claim 11, wherein the computer model determines the accumulated thermal history by modeling at least one of a particle geometry of the RPET, a temperature of each process step, and a residence time of the RPET at each temperature of each process step.

13. A process for decontaminating RPET, comprising:
determining the desired decontamination process steps necessary to achieve a desired level of decontamination of RPET including at least one decontamination process step resulting in a first thermal history of the RPET and performed by a possessor of the RPET, and at least one decontamination process step resulting in a second thermal history of the RPET and performed by a subsequent possessor of the RPET;
determining an accumulated thermal history of the RPET with a computer model, wherein the computer model determines the accumulated thermal history by modeling at least one of a particle geometry of the RPET, a temperature of each process step, and a residence time of the RPET at each temperature of each process step;
optimizing the decontamination process step performed by the possessor of the RPET based on the second thermal history to achieve the desired level of decontamination of the RPET when combined with the decontamination process step performed by the subsequent possessor;
providing a quantity of RPET flakes containing contaminants;
decontaminating the RPET to a level less than the desired level of decontamination with the decontamination process step performed by the possessor; and
decontaminating the RPET to the desired level of decontamination with the decontamination process step performed by the subsequent possessor.

14. The process of claim 13, wherein the decontamination step performed by the possessor is one of a drying step, a grinding step, a washing step, a chemical stripping step, a steam stripping step, a crystallization step, a pelletizing step, a melting step, a solid-stating step, and an extrusion step.

15. The process of claim 13, wherein the decontamination step performed by the subsequent possessor is one of a drying step, a grinding step, a washing step, a chemical stripping step, a steam stripping step, a crystallization step, a pelletizing step, a melting step, a solid-stating step, and an extrusion step.

16. The process of claim 13, wherein each of the desired process steps is performed at a temperature above about 60° C.
